(19) United States
(12) Patent Application Publication
(10) Pub. No.: US 2016/0125987 A1
(43) Pub. Date: May 5, 2016

(54) SOFT MAGNETIC METAL COMPLEX

(71) Applicant: SAMSUNG ELECTRO-MECHANICS CO., LTD., Suwon-Si (KR)

(72) Inventors: Byeong Cheol MOON, Suwon-Si (KR); Se Hyung LEE, Suwon-Si (KR); Il Jin PARK, Suwon-Si (KR)

(21) Appl. No.: 14/921,631

(22) Filed: Oct. 23, 2015

(30) Foreign Application Priority Data
Nov. 4, 2014 (KR) 10-2014-0151970

(51) Int. Cl. H01F 1/20; H01F 1/153; C22C 45/02

(52) U.S. Cl. CPC H01F 1/20; C22C 45/02; H01F 1/15308

(57) ABSTRACT

A soft magnetic metal complex includes a soft magnetic metal powder, an insulating nanopowder, and a polymer resin. Particles of the soft magnetic metal powder are coated with an insulating layer. The soft magnetic metal powder and the insulating nanopowder are contained in the polymer resin.

### CROSS-REFERENCE TO RELATED APPLICATION

This application claims the benefit of priority to Korean Patent Application No. 10-2014-0151970, filed on Nov. 4, 2014 with the Korean Intellectual Property Office, the entirety of which is incorporated herein by reference.

### BACKGROUND

The present disclosure relates to a soft magnetic metal complex having improved insulation properties.

In accordance with the recent development of portable devices such as smartphones, tablet PCs, and the like, demand for high performance dual core and quad core application processors (AP) and large area display devices has increased, such that a sufficient degree of rated current may not be obtained with the use of a ferrite inductor according to the related art. Therefore, various soft magnetic metal inductors formed of a complex of a soft magnetic metal powder and an organic material and having a higher rated current as compared to the ferrite inductor according to the related art have emerged.

However, while there are multiple advantages to the soft magnetic metal inductor, such as excellent DC-bias characteristics, low core loss, and the like, the soft magnetic metal inductor may be disadvantageous in view of withstand voltage because conductors are insulated from each other by a thin insulating layer on a surface of the metal powder in the soft magnetic metal inductor. Furthermore, a breakdown voltage (BDV) of the soft magnetic metal inductor is less than 1/10 that of the ferrite inductor. While there is almost no problem in a buck-type DC-DC converter lowering a voltage of a general cellular phone, in a booster converter or the like used for an organic light emitting diode (OLED) or the like, when a high voltage of 10V or more is momentarily applied to both ends of an inductor, the insulating layer of the surface of the soft magnetic metal powder may be damaged.

In general, because a metal powder of a metal inductor is in a state in which a surface thereof is subjected to insulation-coating, in a product manufactured using the raw material as described above, a method of processing the product after dispersing the raw material with force while minimizing damage to a surface insulating layer, and mixing the raw material with a curable organic material such as an epoxy, or the like, to form a desired shape has mainly been used. In this case, in addition to a coating layer of the raw material, a resin is present in the middle of some interface in which a complete contact is not generated, thereby additionally assisting in insulation properties.

However, since the insulating layer as described above may be damaged during a manufacturing process of the soft magnetic metal inductor, reliability of the soft magnetic metal inductor may be deteriorated as compared to the ferrite inductor.

In particular, since smaller sizes and thinner components have been continuously demanded in electronic devices, it is essential to improve the magnetic permeability thereof. However, since magnetic permeability is proportionate to the packing density of a magnetic material, a ratio of a non-magnetic material in the raw material should be gradually decreased, and a distance between particles should be further decreased. Therefore, since a distance between metal particles may be decreased, a magnitude of an electric field may be increased, which may be disadvantageous in view of insulating resistance and withstand voltage.

As a result, it has been important to develop a technology capable of securing a high degree of magnetic permeability and reliability while miniaturizing and thinning an inductor.

### SUMMARY

One aspect of the present disclosure may provide a soft magnetic metal complex containing an insulating nanopowder, provided to address problems occurring in a soft magnetic metal complex used in an existing metal inductor as described above.

One aspect of the present disclosure may also provide a soft magnetic metal complex containing a ceramic nanopowder or a ferrite nanopowder as an insulating nanopowder.

According to one aspect of the present disclosure, a soft magnetic metal complex may comprise a soft magnetic metal powder, wherein particles of the soft magnetic metal powder are coated with an insulating layer; an insulating nanopowder; and a polymer resin, wherein the soft magnetic metal powder and the insulating nanopowder are contained in the polymer resin.

The soft magnetic metal powder may be one or more of an Fe—Si—Cr-based soft magnetic alloy powder, an Fe—Ni—Mo-based soft magnetic alloy powder, and an Fe—Si—Al-based soft magnetic alloy powder.

The soft magnetic metal powder may be amorphous or nanocrystalline.

The insulating nanopowder may be a ceramic nanopowder.

The ceramic nanopowder may comprise one or more of Al₂O₃, SiO₂, and TiO₂.

The insulating nanopowder may be a ferrite nanopowder.

The ferrite nanopowder may comprise one or more of a NiZn-based ferrite and a NiCuZn-based ferrite.

The polymer resin may be any one of an epoxy resin, a urethane resin, and a silicon resin.

The particles of the insulating nanopowder may be in contact with a surface of the soft magnetic metal powder.

The insulating nanopowder may have an average particle radius of 5 to 500 nm.

According to another aspect of the present disclosure, a soft magnetic metal complex for a power inductor may comprise a soft magnetic metal powder and a polymer resin, and an insulating nanopowder, wherein particles of the insulating nanopowder are disposed between particles of the soft magnetic metal powder.

The insulating nanopowder may contain at least one selected from the group consisting of a ceramic nanopowder and a ferrite nanopowder.

### BRIEF DESCRIPTION OF DRAWINGS

The above and other aspects, features and other advantages of the present disclosure will be more clearly understood from the following detailed description taken in conjunction with the accompanying drawings.

FIG. 1 is a schematic view of a soft magnetic metal complex according to an exemplary embodiment in the present disclosure.

FIG. 2 is a schematic view illustrating a manner in which ceramic nanopowder particles aggregate in the soft magnetic metal complex according to the exemplary embodiment in the present disclosure.

FIG. 3 is a schematic view of a soft magnetic metal complex according to another exemplary embodiment in the present disclosure.

### DETAILED DESCRIPTION

Exemplary embodiments of the present disclosure will now be described in detail with reference to the accompanying drawings.

The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art.

In the drawings, the shapes and dimensions of elements may be exaggerated for clarity, and the same reference numerals will be used throughout to designate the same or like elements.

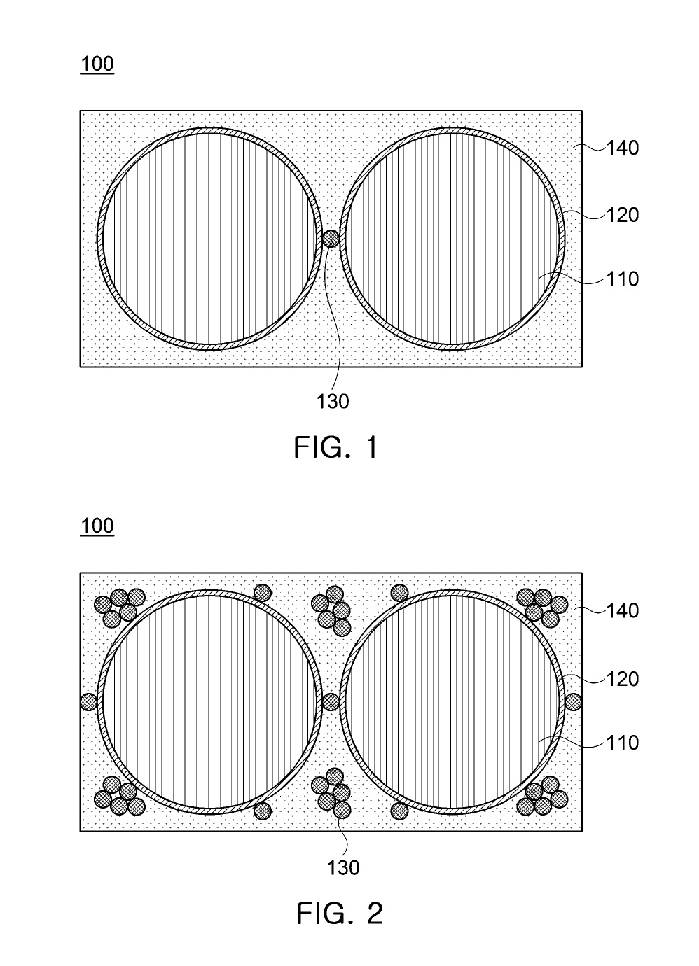

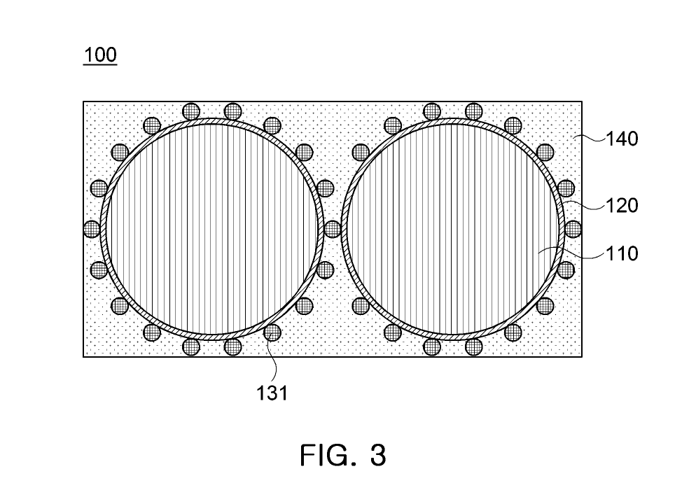

FIG. 1 is a schematic view of a soft magnetic metal complex according to an exemplary embodiment in the present disclosure. FIG. 2 is a schematic view illustrating a manner in which ceramic nanopowder particles are aggregated in the soft magnetic metal complex according to an exemplary embodiment in the present disclosure. FIG. 3 is a schematic view of a soft magnetic metal complex according to another exemplary embodiment in the present disclosure.

Referring to FIGS. 1 and 2, a soft magnetic metal complex 100 may contain soft magnetic metal powder 110 coated with an insulating layer 120, an insulating nanopowder 130, and a polymer resin 140, wherein the soft magnetic metal powder 110 and the insulating nanopowder 130 are dispersed in the polymer resin 140, and the soft magnetic metal complex may be used in the manufacturing of a core or a body of a soft magnetic metal inductor.

The soft magnetic metal powder 110 may serve as a magnetic path in a magnetic component such as an inductor, or the like, and one or more of an Fe—Si—Cr-based soft magnetic metal powder, an Fe—Ni—Mo-based soft magnetic metal powder, and an Fe—Si—Al-based soft magnetic metal powder may be used.

In the Fe—Si—Cr-based soft magnetic metal powder, Cr is a metal which forms a dense oxide film to suppress oxidation of the soft magnetic metal powder but deteriorates magnetic properties, and a content of Cr may be 2.0 to 15.0 wt % based on 100 wt % of the overall amount of soft magnetic metal powder. Further, contents of Mo and Al in the Fe—Ni—Mo-based soft magnetic metal powder and Fe—Si—Al-based soft magnetic metal powder may also be 2.0 to 15.0 wt % based on 100 wt % of the overall amount of soft magnetic metal powder.

When the contents of Cr, Mo, and Al contained in the soft magnetic metal powder are less than 2.0 wt %, the soft magnetic metal powder's effectiveness in suppressing oxidation may be deteriorated, and when the contents are more than 15.0 wt %, the magnetic properties of the soft magnetic metal powder may be deteriorated.

Particles of the soft magnetic metal powder 110 may be coated with the insulating layer 120, such that eddy loss due to electrical resistance generated in an AC electric field may be decreased by the insulating layer 120.

In the insulating layer 120, an organic coating using the polymer resin 140 such as an epoxy, or the like, as well as a metal oxide coating using Fe₂O₃, or the like, and a phosphate coating using zinc phosphate, iron phosphate, manganese phosphate, or the like, may be used, but the insulating layer 120 is not limited thereto.

When the thickness of the insulating layer 120 is increased, withstand voltage characteristics may be improved, but in order to increase magnetic permeability, the content of the soft magnetic metal should be increased. Therefore, the thickness of the insulating layer 120 may be adjusted, depending on the purpose of the product groups using the inductor.

In the present exemplary embodiment, in view of simplifying the production process, it is possible to use an oxide of the Fe—Si—Cr-based soft magnetic metal powder, Fe—Ni—Mo-based soft magnetic metal powder, or Fe—Si—Al-based soft magnetic metal powder as the insulating layer 120. However, the insulating layer 120 may also be formed of the above-mentioned phosphate coating or organic coating, or the like.

Further, as the soft magnetic metal powder 110, an amorphous, nanocrystalline, or metal-based vitreous soft magnetic metal powder 110 may be used.

The insulating nanopowder may be ceramic nanopowder 130, wherein the ceramic nanopowder 130 may be formed of Al₂O₃, SiO₂, or TiO₂.

Particles of the ceramic nanopowder 130 may be interposed between particles of the soft magnetic metal powder 110 as illustrated in FIG. 1 to improve insulation resistance of the soft magnetic metal complex 100, such that the withstand voltage characteristics of the soft magnetic metal inductor may be improved.

Particles of the ceramic nanopowder 130 may have an average particle radius of 5 nm or more but 500 nm or less. When the average particle radius is less than 5 nm, insulation resistance of the soft magnetic metal complex 100 may not be sufficiently improved, and when the average particle radius is greater than 500 nm, magnetic properties of the soft magnetic metal complex 100 may be deteriorated.

Referring to FIG. 3, in a soft magnetic metal complex 100 according to another exemplary embodiment in the present disclosure, a ferrite nanopowder 131 may be used as the insulating nanopowder.

The ferrite nanopowder 131 may be formed of a NiZn-based ferrite and a NiCuZn-based ferrite which has high magnetic permeability and high insulation properties, but the ferrite nanopowder 131 is not limited thereto.

At the time of synthesizing the ferrite nanopowder 131, in a case of dispersing the ferrite nanopowder 131 together with metal particles in a solution of an organic material such as an epoxy, or the like, in a state in which the ferrite nanopowder is solvent-substituted with a finally disposed solvent and dispersed, since the ferrite nanopowder has a single magnetic domain, the ferrite nanopowder 131 itself may have magnetism. Therefore, particles of the ferrite nanopowder 131 may be easily adsorbed onto surfaces of particles of the soft magnetic metal powder 110 having a relatively large size, such that a ratio of particles of ferrite nanopowder 131 coming in contact with the surface of particles of the soft magnetic metal powder 110 to thereby be dispersed in the overall amount of ferrite nanopowder 131 may be increased.

Referring to FIG. 2, in the soft magnetic metal complex 100 according to an exemplary embodiment in the present disclosure, the ceramic nanopowder 130 may be partially dispersed in the complex in an aggregated form, and if the ferrite nanopowder 131 is used as the insulating nanopowder, particles of the insulating nanopowder may be more efficiently distributed on the surfaces of particles of the soft magnetic metal powder.

Therefore, even when the same content of the ferrite nanopowder 131 is contained in the soft magnetic metal complex 100, insulation properties between particles of the soft magnetic metal powder 110 may be efficiently improved, such that the withstand voltage characteristics of the soft magnetic metal inductor may be improved.

The ferrite nanopowder 131 may have an average particle radius of 5 nm or more but 500 nm or less. When the average particle radius is less than 5 nm, insulation resistance of the soft magnetic metal complex 100 may not be sufficiently improved, and when the average particle radius is more than 500 nm, magnetic properties of the soft magnetic metal complex 100 may be deteriorated.

The soft magnetic metal complex 100 according to the exemplary embodiment may contain one or more polymer resins 140 of epoxy, urethane, and silicone resins.

### Comparative Example

An Fe—Si—Al-based soft magnetic metal powder with particles having an average particle radius of 20 μm and coated with an insulating layer were was prepared and dispersed in an epoxy resin, thereby preparing a soft magnetic metal complex for testing magnetic permeability and insulation properties. In this case, a content of the epoxy resin was 1.5 wt % based on the soft magnetic metal complex.

An inductor having an outer diameter of 20 mm, an inner diameter of 13 mm, a thickness of 4 mm, 10 turns, and a toroidal shape was manufactured using the soft magnetic metal complex, and magnetic permeability thereof was measured using a 4982 LCR-meter (by IR Agilent).

Further, after a sample having a diameter of 1 cm and a thickness of 3 mm was manufactured in a disk shape using the soft magnetic metal complex, and resistivity thereof was measured using a 4339B IR-meter (by IR Agilent), a breakdown voltage thereof was measured using a 2410 Source meter (by Kiethley).

### Embodiment 1

An Fe—Si—Al-based soft magnetic metal powder with particles having an average particle radius of 20 μm and coated with an insulating layer were prepared and dispersed together with SiO₂ nanopowder having an average particle radius of 20 nm in an epoxy resin, thereby preparing a soft magnetic metal complex for testing magnetic permeability and insulation properties. In this case, a content of the SiO₂ nanopowder was 0.1 wt % and a content of the epoxy was 1.5 wt %, based on the soft magnetic metal complex.

An inductor having an outer diameter of 20 mm, an inner diameter of 13 mm, a thickness of 4 mm, 10 turns, and a toroidal shape was manufactured using the soft magnetic metal complex, and magnetic permeability thereof was measured using a 4982 LCR-meter (by IR Agilent).

Further, after a sample having a diameter of 1 cm and a thickness of 3 mm was manufactured in a disk shape using the soft magnetic metal complex, and resistivity thereof was measured using a 4339B IR-meter (by IR Agilent), a breakdown voltage thereof was measured using 2410 Source meter (by Kiethley).

### Embodiment 2

An Fe—Si—Al-based soft magnetic metal powder with particles having an average particle radius of 20 μm and coated with an insulating layer were prepared and dispersed together with NiZn ferrite nanopowder having an average particle radius of 20 nm in an epoxy resin, thereby preparing a soft magnetic metal complex for testing magnetic permeability and insulation properties. In this case, a content of the NiZn ferrite nanopowder was 0.1 wt % and a content of the epoxy was 1.5 wt %, based on the soft magnetic metal complex.

An inductor having an outer diameter of 20 mm, an inner diameter of 13 mm, a thickness of 4 mm, 10 turns, and a toroidal shape was manufactured using the soft magnetic metal complex, and magnetic permeability thereof was measured using a 4982 LCR-meter (Agilent).

Further, after a sample having a diameter of 1 cm and a thickness of 3 mm was manufactured in a disk shape using the soft magnetic metal complex, resistivity thereof was measured using 4339B IR-meter (by IR Agilent), and a breakdown voltage thereof was measured using 2410 Source meter (by Kiethley).

TABLE 1

| | | | Breakdown Voltage |
|---|---|---|---|
| | Magnetic Permeability | Resistivity | (BDV, V/mm) |
| Comparative | 20.8 | 2.72e13 | 230 |
| Example | | | |
| Inventive | 20.1 | 8.67e13 | 282 |
| Example 1 | | | |
| Inventive | 20.5 | 1.65e14 | 331 |
| Example 2 | | | |

In the Comparative Example and Embodiments 1 and 2, magnetic permeability was 20.1 to 20.8, such that there was no significant difference in magnetic permeability. However, in the comparative Example in which the insulating nanopowder was not present, resistivity or the breakdown voltage (BDV) indicating a degree of withstand voltage was the lowest, in Embodiment 1 in which the SiO₂ nanopowder was used as the insulating nanopowder, withstand voltage characteristics were high as compared to the Comparative Example. Further, in Embodiment 2 in which the NiZn ferrite nanopowder was used, resistivity and the breakdown voltage (BDV) values were the highest, such that it may be appreciated that withstand voltage characteristics in Embodiment 2 were most excellent.

The reason may be that the insulating nanopowder was interposed in a space between the soft magnetic metal powder to thereby improve the insulation properties as described above. In spite of using the nanopowder with the same content and same size, the withstand voltage characteristics were excellent in Embodiment 2 in which the NiZn ferrite nanopowder was used as compared to Embodiment 1 in which the SiO₂ nanopowder was used. The reason may be that an amount of powder particles distributed on surfaces of particles of the soft magnetic metal powder was increased by the NiZn ferrite nanopowder having magnetism.

As a result, a soft magnetic metal inductor, having magnetic permeability while having improved withstand voltage characteristics, may be provided by adding a small amount of the insulating nanopowder.

As set forth above, according to exemplary embodiments in the present disclosure, the soft magnetic metal complex contains particles of the insulating nanopowder interposed between particles of the soft magnetic metal powder, such that insulation properties between the soft magnetic metal powder may be improved.

Therefore, the breakdown voltage (BDV) of the metal inductor manufactured using the soft magnetic metal powder according to an exemplary embodiment in the present disclosure may be improved, such that the metal inductor of which the withstand voltage characteristics and reliability are improved may be manufactured.

While exemplary embodiments have been shown and described above, it will be apparent to those skilled in the art that modifications and variations could be made without departing from the scope of the present invention as defined by the appended claims.

What is claimed is:

1. A soft magnetic metal complex comprising:
a soft magnetic metal powder, wherein particles of the soft magnetic metal powder are coated with an insulating layer;
an insulating nanopowder; and
a polymer resin,
wherein the soft magnetic metal powder and the insulating nanopowder are contained in the polymer resin.

2. The soft magnetic metal complex of claim 1, wherein the soft magnetic metal powder is one or more of an Fe—Si—Cr-based soft magnetic alloy powder, an Fe—Ni—Mo-based soft magnetic alloy powder, and an Fe—Si—Al-based soft magnetic alloy powder.

3. The soft magnetic metal complex of claim 1, wherein the soft magnetic metal powder is amorphous or nanocrystalline.

4. The soft magnetic metal complex of claim 1, wherein the insulating nanopowder is a ceramic nanopowder.

5. The soft magnetic metal complex of claim 4, wherein the ceramic nanopowder comprises one or more of Al₂O₃, SiO₂, and TiO₂.

6. The soft magnetic metal complex of claim 1, wherein the insulating nanopowder is a ferrite nanopowder.

7. The soft magnetic metal complex of claim 6, wherein the ferrite nanopowder comprises one or more of a NiZn-based ferrite and a NiCuZn-based ferrite.

8. The soft magnetic metal complex of claim 1, wherein the polymer resin is any one of an epoxy resin, a urethane resin, and a silicon resin.

9. The soft magnetic metal complex of claim 1, wherein particles of the insulating nanopowder are in contact with a surface of the soft magnetic metal powder.

10. The soft magnetic metal complex of claim 1, wherein the insulating nanopowder has an average particle radius of 5 to 500 nm.

11. A soft magnetic metal complex for a power inductor comprising a soft magnetic metal powder and a polymer resin, and an insulating nanopowder,
wherein particles of the insulating nanopowder are disposed between particles of the soft magnetic metal powder.

12. The soft magnetic metal complex of claim 11, wherein the insulating nanopowder contains at least one selected from the group consisting of a ceramic nanopowder and a ferrite nanopowder.
